(19) United States
(12) Patent Application Publication
(10) Pub. No.: US 2025/0085392 A1
(43) Pub. Date: Mar. 13, 2025

(54) APPARATUS FOR CONTROLLING VEHICLE AND METHOD THEREOF

(71) Applicants: Hyundai Motor Company, Seoul (KR); Kia Corporation, Seoul (KR)

(72) Inventor: Woo Cheol CHOI, Incheon (KR)

(21) Appl. No.: 18/581,498

(22) Filed: Feb. 20, 2024

(30) Foreign Application Priority Data
Sep. 13, 2023 (KR) 10-2023-0122060

(51) Int. Cl. G01S 7/48; G01S 17/42; G01S 17/931

(52) U.S. Cl. CPC G01S 7/4802; G01S 17/42; G01S 17/931

(57) ABSTRACT

An apparatus may comprise a first sensor, a second sensor, and a processor configured to obtain data related to an object in front of the vehicle driving along a first axis, project points in the data onto a plane formed by a second axis, being perpendicular to the first axis, and a third axis being perpendicular to the first axis and the second axis, determine first points obtained by the first sensor and second points obtained by the second sensor, obtain a vector indicating a separation between first subset of the first points and second subset of the second points, determine, based on the vector, whether the first points match the second points, adjust, based on the determination of whether the first points match the second points, a separation between the first points and the second points, and output a signal indicating the adjusted separation.

### CROSS-REFERENCE TO RELATED APPLICATION

This application claims the benefit of priority to Korean Patent Application No. 10-2023-0122060, filed in the Korean Intellectual Property Office on Sep. 13, 2023, the entire contents of which are incorporated herein by reference.

### TECHNICAL FIELD

The present disclosure relates to an apparatus for controlling a vehicle and a method thereof, and more specifically, relates to a technology for detecting an external object by using a plurality of sensors (e.g., LiDARs).

### BACKGROUND

Various studies are being conducted to identify an external object by using various sensors to assist a host vehicle in driving.

In particular, while the host vehicle is driving in a driving assistance device activation mode or an autonomous driving mode, the external object may be identified by using sensor(s) (e.g., light detection and ranging (LiDAR)).

However, it is assumed that the host vehicle includes a plurality of sensors (e.g., LiDARs). If a plurality of points obtained by the plurality of LiDARs do not match with each other, the external object may be incorrectly identified. If the external object is incorrectly identified, the driving direction of the external object or the size of the external object may be incorrectly identified, and thus a driving route of the host vehicle may be set incorrectly or an accident may occur.

### SUMMARY

According to the present disclosure, an apparatus for controlling a vehicle, the apparatus may comprise a first sensor; a second sensor; and a processor, wherein the processor is configured to obtain, from the first sensor and the second sensor, data sets related to a moving object in front of the vehicle that is driving along a first axis; project a plurality of points included in the data sets onto a plane formed by a second axis and a third axis, wherein the plurality of points indicate a rear surface of the moving object; the second axis, being perpendicular to the first axis, lies in a horizontal plane; and the third axis, being perpendicular to the first axis and the second axis, lies in a vertical plane; determine, based on the projection, a plurality of first points, of the plurality of points, obtained by the first sensor, and a plurality of second points, of the plurality of points, obtained by the second sensor; determine a first subset of points included in the plurality of first points and a second subset of points included in the plurality of second points; obtain, based on the first subset, a first polygon; obtain, based on the second subset, a second polygon; obtain, based on points of the first polygon and the second polygon, a vector indicating a separation between the first subset and the second subset; determine, based on the vector, whether the plurality of first points match the plurality of second points; adjust, based on the determination of whether the plurality of first points match the plurality of second points, a separation between the plurality of first points and the plurality of second points; and output a signal indicating the adjusted separation. The apparatus, may further comprises output, based on the adjusted separation, a signal to control the vehicle.

The apparatus, wherein the processor is configured to obtain the first polygon and the second polygon based on the moving object being identified at a distance from the vehicle, wherein the distance is greater than or equal to a first threshold distance and is smaller than or equal to a second threshold distance exceeding the first threshold distance.

The apparatus, wherein the first sensor is configured to detect an external object in a first range, wherein the second sensor is configured to detect the external object in a second range different from the first range, and wherein the processor is configured to obtain the first polygon and the second polygon based on the moving object being identified in a range where the first range and the second range overlap with each other.

The apparatus, wherein the processor is configured to obtain the first polygon and the second polygon based on the moving object moving straight in front of the vehicle.

The apparatus, wherein the processor is configured to identify, based on sampling the plurality of points, the plurality of first points and the plurality of second points.

The apparatus, wherein the processor is configured to determine first minimum values and first maximum values of first points on first layers, wherein each layer of the first layers is formed of a subset of points, of the plurality of first points, along the second axis; determine first intermediate values of first intermediate points on a top most layer of the first layers and a bottom most layer of the first layers; obtain the first polygon by connecting the first minimum values, the first maximum values, and the first intermediate values; determine second minimum values and second maximum values of second points on second layers, wherein each layer of the second layers is formed of a subset of points, of the plurality of second points, along the second axis; determine second intermediate values of second intermediate points on a top most layer of the second layers and a bottom most layer of the second layers; and obtain the second polygon by connecting the second minimum values, the second maximum values, and the second intermediate values.

The apparatus, wherein the processor is configured to obtain the vector based on one of the first minimum values of the first points on a first one of the first layers, and one of the second minimum values of the second points on a first one of the second layers, wherein the first one of the second layers is of a same order as the first one of the first layers; obtain the vector based on one of the first maximum values of the first points on a second one of the first layers, and one of the second maximum values of the second points on a second one of the second layers, wherein the second one of the second layers is of a same order as the second one of the first layers; obtain the vector based on one of the first intermediate values of the first intermediate points on the top most layer of the first layers, and one of the second intermediate values of the second intermediate points on the top most layer of the second layers; or obtain the vector based on one of the first intermediate values of the first intermediate points on the bottom most layer of the first layers, and one of the second intermediate values of the second intermediate points on the bottom most layer of the second layers.

The apparatus, wherein the processor is configured to determine that the plurality of first points do not match the plurality of second points in a yaw direction, based on identifying a component of the second axis in the obtained vector; and adjust the separation between the plurality of first points and the plurality of second points based on the component of the second axis in the obtained vector.

The apparatus, wherein the processor is configured to determine that the plurality of first points do not match the plurality of second points in a pitch direction, based on identifying a component of the third axis in the obtained vector; and adjust the separation between the plurality of first points and the plurality of second points based on the component of the third axis in the obtained vector.

The apparatus, wherein the plane includes a first plane, and wherein the processor is configured to obtain, based on sensing data of the first sensor and the second sensor, a top point and a bottom point on a second plane, which is formed by the first axis and the third axis and is different from the first plane; determine that the plurality of first points do not match the plurality of second points in a pitch direction, based on identifying at least one of the top point, the bottom point, or a component of the third axis of the obtained vector; and adjust the separation between the plurality of first points and the plurality of second points based on at least one of the top point, the bottom point, or the component of the third axis of the obtained vector.

According to the present disclosure, a method for controlling a vehicle, the method may comprise obtaining, from a first sensor and a second sensor, data sets related to a moving object in front of the vehicle that is driving along a first axis; projecting a plurality of points included in the data sets onto a plane formed by a second axis and a third axis, wherein the plurality of points indicate a rear surface of the moving object; the second axis, being perpendicular to the first axis, lies in a horizontal plane; and the third axis, being perpendicular to the first axis and the second axis, lies in a vertical plane; determining, based on the projecting, a plurality of first points, of the plurality of points, obtained by the first sensor, and a plurality of second points, of the plurality of points, obtained by the second sensor; determining a first subset of points included in the plurality of first points and a second subset of points included in the plurality of second points; obtaining, based on the first subset, a first polygon; obtaining, based on the second subset, a second polygon; obtaining, based on points of the first polygon and the second polygon, a vector indicating a separation between the first subset and the second subset; determining, based on the vector, whether the plurality of first points match the plurality of second points; adjusting, based on the determining whether the plurality of first points match the plurality of second points, a separation between the plurality of first points and the plurality of second points; and outputting a signal indicating the adjusted separation.

The method, may further comprise obtaining the first polygon and the second polygon based on the moving object being identified at a distance from the vehicle, wherein the distance is greater than or equal to a first threshold distance and is smaller than or equal to a second threshold distance exceeding the first threshold distance.

The method, may further comprise detecting, using the first sensor, an external object in a first range, detecting, using the second sensor, the external object in a second range different from the first range, and obtaining the first polygon and the second polygon based on the moving object being identified in a range where the first range and the second range overlap with each other.

The method, may further comprise obtaining the first polygon and the second polygon based on the moving object moving straight in front of the vehicle.

The method, may further comprise identifying, based on sampling the plurality of points, the plurality of first points and the plurality of second points.

The method, may further comprise determining first minimum values and first maximum values of first points on first layers, wherein each layer of the first layers is formed of a subset of points, of the plurality of first points, along the second axis; determining first intermediate values of first intermediate points on a top most layer of the first layers and a bottom most layer of the first layers; obtaining the first polygon by connecting the first minimum values, the first maximum values, and the first intermediate values; determining second minimum values and second maximum values of second points on second layers, wherein each layer of the second layers is formed of a subset of points, of the plurality of second points, along the second axis; determining second intermediate values of second intermediate points on a top most layer of the second layers and a bottom most layer of the second layers; and obtaining the second polygon by connecting the second minimum values, the second maximum values, and the second intermediate values.

The method, may further comprise obtaining the vector based on one of the first minimum values of the first points on a first one of the first layers, and one of the second minimum values of the second points on a first one of the second layers, wherein the first one of the second layers is of a same order as the first one of the first layers; obtaining the vector based on one of the first maximum values of the first points on a second one of the first layers, and one of the second maximum values of the second points on a second one of the second layers, wherein the second one of the second layers is of a same order as the second one of the first layers; obtaining the vector based on one of the first intermediate values of the first intermediate points on the top most layer of the first layers, and one of the second intermediate values of the second intermediate points on the top most layer of the second layers; or obtaining the vector based on one of the first intermediate values of the first intermediate points on the bottom most layer of the first layers, and one of the second intermediate values of the second intermediate points on the bottom most layer of the second layers.

The method, may further comprise determining that the plurality of first points do not match the plurality of second points in a yaw direction, based on identifying a component of the second axis in the obtained vector; and adjusting the separation between the plurality of first points and the plurality of second points based on the component of the second axis in the obtained vector.

The method, may further comprise determining that the plurality of first points do not match the plurality of second points in a pitch direction, based on identifying a component of the third axis in the obtained vector; and adjusting the separation between the plurality of first points and the plurality of second points based on the component of the third axis in the obtained vector.

The method, wherein the plane includes a first plane, and wherein the method may further comprise obtaining, based on sensing data of the first sensor and the second sensor, a top point and a bottom point on a second plane, which is formed by the first axis and the third axis and is different from the first plane; determining that the plurality of first points do not match the plurality of second points in a pitch direction, based on identifying at least one of the top point, the bottom point, or a component of the third axis of the obtained vector; and adjusting the separation between the plurality of first points and the plurality of second points based on at least one of the top point, the bottom point, or the component of the third axis of the obtained vector.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram of a vehicle control apparatus, according to an example of the present disclosure;

FIG. 2 shows an example in which an external vehicle is identified by LiDAR included in a vehicle control apparatus, according to an example of the present disclosure;

FIG. 3 shows an example of a plurality of points representing the rear surface of an external vehicle, in an example of the present disclosure;

FIG. 4 shows an example of obtaining a representative point from a plurality of points indicating a rear surface of an external vehicle, in an example of the present disclosure;

FIG. 5 shows an example of obtaining a vector by determining whether representative points match each other, in an example of the present disclosure;

FIG. 6 shows an example of determining whether pitch directions between a plurality of points match each other, in an example of the present disclosure;

FIG. 7 shows an example of a flowchart of a vehicle control method, according to an example of the present disclosure;

FIG. 8 shows an example of a flowchart of a vehicle control method, according to an example of the present disclosure; and

FIG. 9 shows an example of a computing system including a vehicle control apparatus, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components have the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

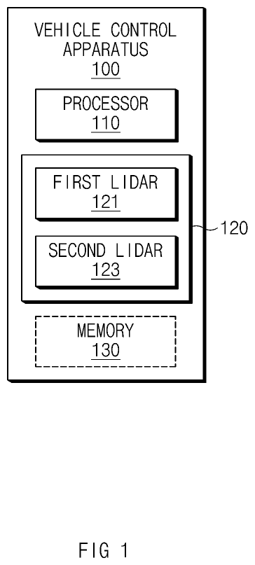

Hereinafter, various examples of the present disclosure will be described in detail with reference to FIGS. 1 to 9.

FIG. 1 shows an example of a block diagram of a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be connected to control units of the vehicle by means of a separate connection means. For example, the vehicle control apparatus 100 may further include components not shown in FIG. 1.

According to an example of the present disclosure, the vehicle control apparatus 100 may include a processor 110, a first LiDAR 121, and a second LiDAR 123. The processor 110, the first LiDAR 121, or the second LiDAR 123 may be electrically or operably connected to each other by an electronic component including a communication bus.

In an example, the vehicle control apparatus 100 may further include a memory 130. The processor 110, the first LiDAR 121, the second LiDAR 123, or the memory 130 may be electrically or operably connected to each other by electronic components including a communication bus.

Hereinafter, the fact that pieces of hardware are coupled operably may include the fact that a direct or indirect connection between the pieces of hardware is established wired or wirelessly such that second hardware is controlled by first hardware among the pieces of hardware. Although different blocks are shown, an example is not limited thereto.

Some of the pieces of hardware in FIG. 1 may be included in a single integrated circuit including a system on a chip (SoC). The type or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may have the structure of a single-core processor, or may have a structure of a multi-core processor including a dual core, a quad core, a hexa core, or an octa core.

The vehicle control apparatus 100 according to an example may include the plurality of LiDARs 120 including at least one of the first LiDAR 121, the second LiDAR 123, or any combination thereof. For example, the first LiDAR 121 may obtain data sets from identifying objects surrounding the vehicle control apparatus 100.

For example, the first LiDAR 121 may identify at least one of a location of a surrounding object, a movement direction of the surrounding object, a speed of the surrounding object, or any combination thereof based on a pulse laser signal that is emitted from the first LiDAR 121, reflected by the surrounding object, and returned. For example, the first LiDAR 121 may be placed in front of a host vehicle so as to be toward the right and may identify an external object in a first specified range.

For example, the second LiDAR 123 may identify at least one of a location of the surrounding object, a movement direction of the surrounding object, a speed of the surrounding object, or any combination thereof based on a pulse laser signal that is emitted from the second LiDAR 123, reflected by the surrounding object, and returned. For example, the second LiDAR 123 may be placed in front of the host vehicle so as to be toward the left and may identify an external object in a second specified range.

For convenience of description, the plurality of LiDARs 120 includes the first LiDAR 121 and the second LiDAR 123, but an example is not limited thereto. For example, the plurality of LiDARs 120 may further include another LiDAR in addition or alternative to the first LiDAR 121 and the second LiDAR 123.

The vehicle control apparatus 100 according to an example may include a memory 130. For example, the memory 130 may include a hardware component for storing data or instructions that are to be input or output to the processor 110 of the vehicle control apparatus 100. For example, the memory 130 may include a volatile memory including a random-access memory (RAM), or a non-volatile memory including a read-only memory (ROM).

For example, the volatile memory may include at least one of a dynamic RAM (DRAM), a static RAM (SRAM), a cache RAM, a pseudo SRAM (PSRAM), or any combination thereof. For example, the non-volatile memory includes at least one of a programmable ROM (PROM), an erasable PROM (EPROM), an electrically erasable PROM (EEPROM), a flash memory, a hard disk, a compact disk, a solid state drive (SSD), an embedded multi-media card (eMMC), or any combination thereof.

In an example, while the host vehicle is driving, the processor 110 may obtain data sets related to an external vehicle, which is different from the host vehicle and which is driving in front of the host vehicle, based on the plurality of LiDARs 120 including the first LiDAR 121 and the second LiDAR 123. For example, the processor 110 may obtain data sets related to an external vehicle based on identifying an external vehicle driving straight in front of the host vehicle. The data sets may include a plurality of points based on light reflected from an external vehicle, in a three-dimensional virtual coordinate system based on an x-axis, a y-axis, and a z-axis.

In an example, the processor 110 may project a plurality of points, which are included in the data sets, onto a plane formed by the second axis and the third axis among the first axis, the second axis, and the third axis. For example, a plurality of points may include a plurality of points corresponding to the rear surface of an external vehicle driving straight in front of the host vehicle.

For example, the first axis may include the x-axis. For example, the second axis may include the y-axis. For example, the third axis may include the z-axis. For example, the first axis, the second axis, and the third axis may be perpendicular to each other and may be intersect each other based on an origin point. The first axis, the second axis, and the third axis are not limited to the above examples. Hereinafter, for convenience of description, the first axis is described as the x-axis; the second axis is described as the y-axis; and the third axis is described as the z-axis.

In an example, the processor 110 may obtain the plurality of points corresponding to the rear surface of the external vehicle based on the fact that the external vehicle is identified at a distance from the host vehicle, which is greater than or equal to a first specified distance and is smaller than or equal to a second specified distance exceeding the first specified distance.

In an example, the processor 110 may obtain the plurality of points corresponding to the rear surface of the external vehicle, based on identifying the external vehicle in a range where a first specified range, in which the external object is identified by the first LiDAR 121, and a second specified range in which the external object is identified by the second LiDAR 123 are superimposed with each other.

In an example, while the external vehicle is driving straight in front of the host vehicle, the processor 110 may obtain a plurality of points corresponding to the rear surface of the external vehicle.

In an example, the processor 110 may perform at least one of an operation of obtaining representative points, an operation of obtaining polygons, an operation of obtaining a vector, or any combination thereof based on obtaining the plurality of points corresponding to the rear surface of the external vehicle.

In an example, the processor 110 may obtain the plurality of points corresponding to the rear surface of the external vehicle based on the fact that the external vehicle is driving straight in front of the host vehicle at a distance from the host vehicle between the first specified distance and the second specified distance while the host vehicle is driving straight on a flat road on a sunny day, and the external object is identified in the superimposed range where both the first LiDAR 121 and the second LiDAR 123 identify the external object.

In an example, the processor 110 may sample the plurality of points. For example, the processor 110 may separate and identify a plurality of first points obtained by the first LiDAR 121 and a plurality of second points obtained by the second LiDAR 123 based on sampling the plurality of points.

For example, the processor 110 may identify at least one of the plurality of first points obtained by the first LiDAR 121, the plurality of second points obtained by the second LiDAR 123, or any combination thereof among the plurality of points corresponding to the rear surface of an external vehicle based on projecting the plurality of points included in the data sets onto one plane formed by the y-axis and z-axis among the x-axis, y-axis, and z-axis. For example, the processor 110 may identify the plurality of first points obtained by the first LiDAR 121 and the plurality of second points obtained by the second LiDAR 123.

In an example, the processor 110 may identify first representative points based on the plurality of first points. For example, the processor 110 may obtain the first representative points corresponding to outermost points included in the plurality of first points. The processor 110 may obtain a first polygon from connecting the first representative points.

For example, in layers on each of which the plurality of first points are identified, the processor 110 may identify at least one of first minimum values based on the y-axis, first maximum values based on the y-axis, or any combination thereof. For example, in at least one layer of a top layer, a bottom layer, or any combination thereof, on each of which the plurality of first points are identified, the processor 110 may identify first intermediate values of the plurality of first points. The processor 110 may obtain the first polygon based on the first minimum values based on the y-axis, the first maximum values based on the y-axis, and the first intermediate values of the top layer and the bottom layer. For example, the processor 110 may obtain the first polygon from connecting the first minimum values based on the y-axis, the first maximum values based on the y-axis, and the first intermediate values of the top layer and bottom layer.

In an example, the processor 110 may identify second representative points based on the plurality of second points. For example, the processor 110 may obtain the second representative points corresponding to outermost points included in the plurality of second points. The processor 110 may obtain a second polygon from connecting the second representative points.

For example, in layers on each of which the plurality of second points are identified, the processor 110 may identify at least one of second minimum values based on the y-axis, second maximum values based on the y-axis, or any combination thereof. For example, in at least one layer of a top layer, a bottom layer, or any combination thereof, on each of which the plurality of second points are identified, the processor 110 may identify second intermediate values of the plurality of second points. The processor 110 may obtain the second polygon based on the second minimum values based on the y-axis, the second maximum values based on the y-axis, and the second intermediate values of the top layer and the bottom layer. For example, the processor 110 may obtain the second polygon from connecting the second minimum values based on the y-axis, the second maximum values based on the y-axis, and the second intermediate values of the top layer and bottom layer.

In an example, the processor 110 may obtain the first polygon corresponding to the first representative points and the second polygon corresponding to the second representative points through the first representative points corresponding to the outermost points included in the plurality of first points, and the second representative points corresponding to the outermost points included in the plurality of second points. On the basis of obtaining the first polygon and second polygon, the processor 110 may obtain a vector indicating the separation between the first representative points and the second representative points by using all or part of the first representative points and the second representative points included in the first polygon and second polygon.

For example, the processor 110 may apply an iterative closest point (ICP) algorithm to the first representative points and the second representative points. The processor 110 may obtain a vector indicating the separation between first representative points and second representative points, by applying the ICP algorithm to the first representative points and the second representative points included in the first polygon and the second polygon.

In an example, the processor 110 may identify one of the first minimum values included in one of each of the layers including the plurality of first points. The processor 110 may obtain the vector indicating the separation between the first representative points and the second representative points based on the one of the first minimum values included in one of each of the layers including the plurality of first points, and one of the second minimum values included in a layer of the same order.

In an example, the processor 110 may identify one of the first maximum values included in one of each of the layers including the plurality of first points. The processor 110 may obtain a vector indicating the separation between the first representative points and the second representative points based on the one of the first maximum values included in one of each of the layers including the plurality of first points, and one of the second maximum values included in a layer of the same order.

In an example, the processor 110 may obtain the vector indicating the separation between first representative points and second representative points based on one of the first intermediate values included in the top layer, on which the plurality of first points are identified, and one of the second intermediate values included in the top layer, on which the plurality of second points are identified.

In an example, the processor 110 may obtain the vector indicating the separation between first representative points and second representative points based on one of the first intermediate values included in the bottom layer, on which the plurality of first points are identified, and one of the second intermediate values included in the bottom layer, on which the plurality of second points are identified.

In an example, the processor 110 may determine whether the plurality of first points matches the plurality of second points, through the obtained vector. The processor 110 may identify that the plurality of first points and the plurality of second points do not match each other in a yaw direction, based on identifying a y-axis component in the obtained vector. The processor 110 may correct the separation between the plurality of first points and the plurality of second points based on the y-axis component in the obtained vector.

In an example, the processor 110 may identify that a mounting angle of at least one of the first LiDAR 121, the second LiDAR 123, or any combination thereof is changed, based on the obtained vector including the y-axis component. The processor 110 may identify that at least one of the first LiDAR 121, the second LiDAR 123, or any combination thereof is distorted in the yaw direction, based on the obtained vector including the y-axis component. The processor 110 may correct the separation between the plurality of first points and the plurality of second points based on the fact that at least one of the first LiDAR 121, the second LiDAR 123, or any combination thereof is distorted in the yaw direction. Alternatively or additionally, the processor 110 may reduce the reliability of data sets obtained by at least one of the first LIDAR 121, the second LiDAR 123, or any combination thereof based on the fact that at least one of the first LiDAR 121, the second LiDAR 123, or any combination thereof is distorted in the yaw direction.

In an example, the processor 110 may identify that the plurality of first points and the plurality of second points do not match each other in a pitch direction, based on identifying a z-axis component in the obtained vector. The processor 110 may correct the separation between the plurality of first points and the plurality of second points based on a z-axis component in the obtained vector.

In an example, the processor 110 may identify that the mounting angle of one of the first LiDAR 121, the second LiDAR 123, or any combination thereof is changed, based on the obtained vector including the z-axis component. The processor 110 may identify that at least one of the first LiDAR 121, the second LiDAR 123, or any combination thereof is distorted in the pitch direction based on the obtained vector including the z-axis component. The processor 110 may correct the separation between the plurality of first points and the plurality of second points based on the fact that at least one of the first LiDAR 121, the second LiDAR 123, or any combination thereof is distorted in the pitch direction. Alternatively or additionally, the processor 110 may reduce the reliability of data sets obtained by at least one of the first LiDAR 121, the second LiDAR 123, or any combination thereof based on the fact that at least one of the first LiDAR 121, the second LiDAR 123, or any combination thereof is distorted in the pitch direction.

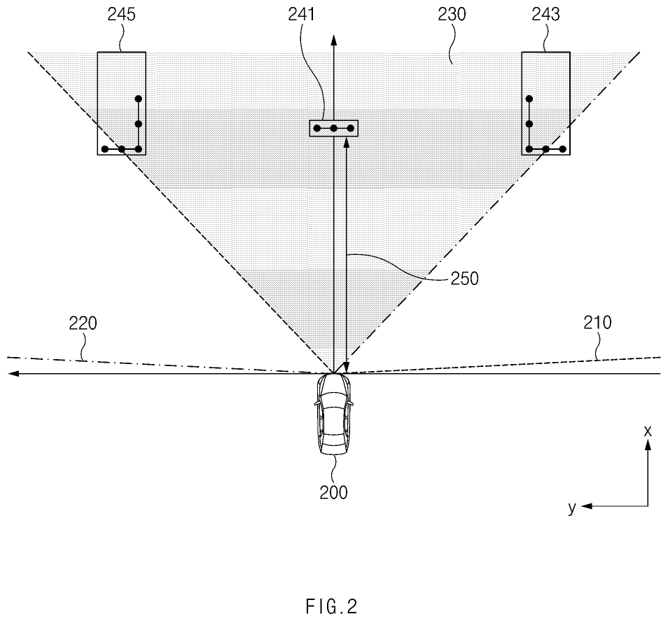

FIG. 2 shows an example in which an external vehicle is identified by LiDAR included in a vehicle control apparatus, according to an example of the present disclosure.

Operations of FIG. 2 may be performed by the vehicle control apparatus 100 of FIG. 1, or may be performed by the processor 110 included in the vehicle control apparatus 100 of FIG. 1.

Referring to FIG. 2, a vehicle control apparatus according to an example may be included in a host vehicle 200. For example, a plurality of LiDARs in the vehicle control apparatus included in the host vehicle 200 may identify an external object. For example, the first LiDAR among the plurality of LiDARs may be placed toward the right side of the host vehicle 200. For example, the second LiDAR among the plurality of LiDARs may be placed toward the left side of the host vehicle 200. However, an example is not limited thereto.

For example, a first LiDAR may be placed in the front of the host vehicle 200 toward the right side of the host vehicle 200. For example, a second LiDAR may be placed in the front of the host vehicle 200 toward the left side of the host vehicle 200.

For example, the first LiDAR may be placed toward the right side of the host vehicle 200 to identify external objects 241, 243, and 245 in a first specified range 210. For example, the second LiDAR may be placed toward the left side of the host vehicle 200 to identify the external objects 241, 243, and 245 in a second specified range 220.

In an example, a processor may identify at least one of the external objects 241, 243, and 245 by using at least one of the first LiDAR, the second LiDAR, or any combination thereof.

For example, the processor may identify at least one of the external objects 241, 243, and 245 based on data sets obtained by using at least one of the first LiDAR, the second LiDAR, or any combination thereof. The processor may identify at least one of the external objects 241, 243, and 245 based on data sets including a three-dimensional virtual coordinate system based on an x-axis, a y-axis, and a z-axis.

According to an example, the processor may project a plurality of points represented on the x-axis, the y-axis, and the z-axis onto a plane formed by the y-axis and z-axis. The plurality of points described below may include a plurality of points projected onto one plane formed by the y-axis and the z-axis.

In an example, the processor may identify the external vehicle 241 among the external objects 241, 243, and 245 in a range 230 where the first specified range 210 and the second specified range 220 superimposed with each other. The processor may identify a plurality of points indicating the rear surface of the external vehicle 241 based on identifying the external vehicle 241 in the range 230 where the first specified range 210 and the second specified range 220 superimposed with each other.

In an example, the processor may identify the plurality of points based on a distance 250 between the external vehicle 241 and the host vehicle 200. For example, the processor may obtain polygons by using the plurality of points indicating the rear surface of the external vehicle 241 based on the external vehicle 241 being identified at a distance from the host vehicle 200 that is greater than or equal to a first specified distance and is less than or equal to a second specified distance exceeding the first specified distance. For example, the first specified distance may include approximately 40 m. For example, the second specified distance may include approximately 60 m.

In an example, the processor may identify the plurality of points corresponding to the rear surface of the external vehicle 241 based on the fact that the external vehicle 241 is driving straight, the distance 250 between the host vehicle 200 and the external vehicle 241 is greater than or equal to the first specified distance and less than or equal to the second specified distance, and the external vehicle 241 is identified in the range 230 where the first specified range 210 and the second specified range 220 superimposed with each other. The processor may identify a plurality of first points obtained by the first LiDAR, and a plurality of second points obtained by the second LiDAR, among the plurality of points.

In an example, the processor may correct the separation between the plurality of first points and the plurality of second points based on whether the plurality of first points and the plurality of second points match each other. To correct the separation between the plurality of first points and the plurality of second points, the following descriptions may include operations for determining whether the plurality of first points and the plurality of second points are spaced from each other or match each other.

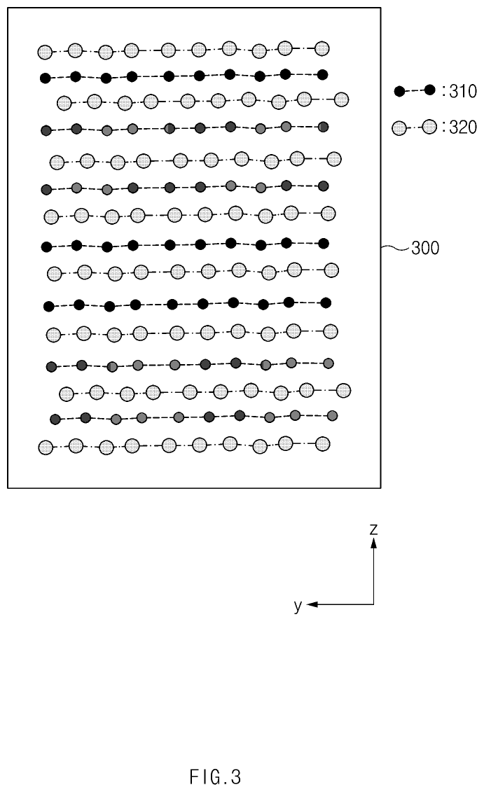

FIG. 3 shows an example of a plurality of points representing the rear surface of an external vehicle, in an example of the present disclosure.

Operations of FIG. 3 may be performed by the vehicle control apparatus 100 of FIG. 1, or may be performed by the processor 110 included in the vehicle control apparatus 100 of FIG. 1.

A processor of the vehicle control apparatus according to an example may obtain a plurality of points 300 based on satisfying at least one of a first condition, a second condition, a third condition, or any combination thereof. For example, the first condition may be related to whether an external vehicle is driving straight in front of a host vehicle. For example, the second condition may be related to whether a distance between the host vehicle and the external vehicle is greater than or equal to a first specified distance, and whether the external vehicle is present within a second specified distance or less that exceeds the first specified distance. For example, the third condition may relate to whether the external vehicle, which is identified by a first LIDAR for identifying an external object in a first specified range and a second LiDAR for identifying an external object in a second specified range, is identified in a range where the first specified range and the second specified range superimposed with each other.

For example, a case where the first condition is satisfied may include a case where the external vehicle is driving straight in front of the host vehicle. For example, a case where the second condition is satisfied may include a case where the distance between the host vehicle and the external vehicle is greater than or equal to the first specified distance, and the external vehicle is present within the second specified distance or less that exceeds the first specified distance. For example, a case where the third condition is satisfied may include a case where the external vehicle is identified in a range where the first specified range and the second specified range superimposed with each other.

For example, if the first condition, the second condition, and the third condition are satisfied, the processor may obtain polygons by using the plurality of points 300 corresponding to the rear surface of the external vehicle.

In an example, the processor may obtain a plurality of first points 310 by using the first LiDAR. In an example, the processor may obtain a plurality of second points 320 by using the second LiDAR. For example, the processor may obtain the plurality of first points 310 by using the first LiDAR, and may obtain the plurality of second points 320 by using the second LiDAR.

In an example, the processor may separate the plurality of first points 310 obtained by using the first LiDAR and the plurality of second points 320 obtained by using second LiDAR and may store the plurality of first points 310 and the plurality of second points 320 in a memory.

In an example, the processor may project the plurality of points 300 onto a plane based on a y-axis and a z-axis among an x-axis, the y-axis, and the z-axis. For example, the processor may project the plurality of first points 310 and the plurality of second points 320 onto the plane based on the y-axis and the z-axis among the x-axis, the y-axis, and the z-axis.

For example, the processor may group the plurality of first points 310 projected onto one plane based on a layer. For example, the processor may group the plurality of first points 310 based on layers formed based on the z-axis. The processor may store the grouped plurality of first points 310 in a first area of the memory.

For example, the processor may group the plurality of second points 320 projected onto one plane based on a layer. For example, the processor may group the plurality of second points 320 based on the layers formed based on the z-axis. The processor may store the grouped plurality of second points 320 in a second area of the memory.

As described above, according to an example, to use the plurality of first points 310 and the plurality of second points 320 as inputs to an ICP algorithm, the processor may separate the plurality of first points 310 and the plurality of second points 320 and may store the plurality of first points 310 and the plurality of second points 320 in the memory.

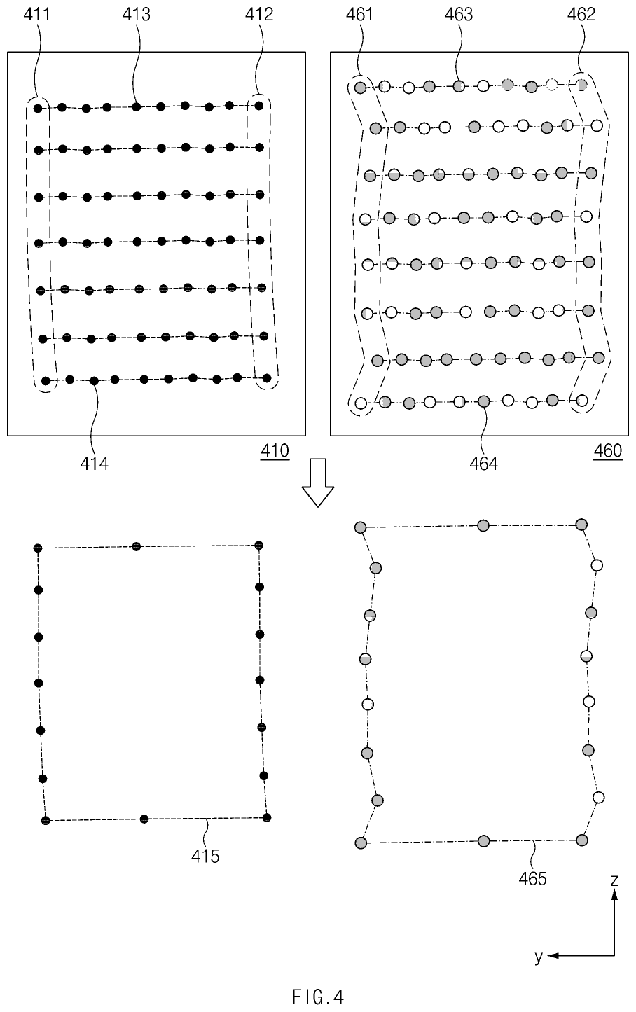

FIG. 4 shows an example of obtaining a representative point from a plurality of points indicating a rear surface of an external vehicle, in an example of the present disclosure.

Operations of FIG. 4 may be performed by the vehicle control apparatus 100 of FIG. 1, or may be performed by the processor 110 included in the vehicle control apparatus 100 of FIG. 1.

Referring to FIG. 4, a processor of a vehicle control apparatus according to an example may obtain a plurality of first points 410 based on a first LiDAR. In an example, the processor may obtain a plurality of second points 460 based on a second LiDAR.

For example, the processor may obtain the plurality of first points 410 by using the first LiDAR placed towards the right side of a host vehicle. For example, the processor may obtain the plurality of second points 460 by using the second LiDAR placed towards the left side of the host vehicle.

The plurality of first points 410 and the plurality of second points 460 in FIG. 4 may include an example of a plurality of points projected onto a plane formed by a y-axis and a z-axis among an x-axis, the y-axis, and the z-axis.

According to an example, the processor may separate the plurality of first points 410 and the plurality of second points 460 and may store the plurality of first points 410 and the plurality of second points 420 in a memory. To use the plurality of first points 410 and the plurality of second points 460 as inputs to an ICP algorithm, the processor may separate the plurality of first points 410 and the plurality of second points 460 and may store the plurality of first points 410 and the plurality of second points 420 in the memory.

In an example, the processor may identify representative points of the plurality of first points 410. The processor may identify representative points based on at least one of first minimum values, first maximum values, or any combination thereof on each of layers, each including the plurality of first points 410. For example, the processor may identify the representative points based on first minimum values 411 and first maximum values 412 in each of layers, each including the plurality of first points 410.

The processor may identify intermediate values in each of a top layer and a bottom layer among the layers, each including the plurality of first points. For example, the processor may identify an intermediate value 413 in the top layer, and may identify an intermediate value 414 in the bottom layer. The processor may identify the intermediate value 413 in the top layer and the intermediate value 414 in the bottom layer as representative points.

In an example, the processor may obtain a polygon 415 based on at least one of the first minimum values 411, the first maximum values 412, the first intermediate values 413 and 414, or any combination thereof. For example, the processor may obtain the polygon 415 from connecting the first minimum values 411, the first maximum values 412, and the first intermediate values 413 and 414.

In an example, the processor may identify representative points of the plurality of second points 460. The processor may identify representative points based on at least one of a minimum value, a maximum value, or any combination thereof on each of layers, each including the plurality of second points 460. For example, the processor may identify the representative points based on minimum values 461 and maximum values 462 in each of layers, each including the plurality of second points 460.

The processor may identify intermediate values in each of a top layer and a bottom layer among the layers, each including the plurality of second points 460. For example, the processor may identify an intermediate value 463 in the top layer, and may identify an intermediate value 464 in the bottom layer. The processor may identify the intermediate value 463 in the top layer and the intermediate value 464 in the bottom layer as representative points.

In an example, the processor may obtain a polygon 465 based on at least one of the minimum values 461, the maximum values 462, the intermediate values 463 and 464, or any combination thereof. For example, the processor may obtain the polygon 465 from connecting the minimum values 461, the maximum values 462, and the intermediate values 463 and 464 by using a line.

In an example, the processor may input the obtained polygons 415 and 465 into an ICP algorithm. The processor may determine whether the polygons 415 and 465 are matched with each other, based on inputting the obtained polygons 415 and 465 into the ICP algorithm. For example, the processor may obtain a vector based on inputting the obtained polygons 415 and 465 into the ICP algorithm. The processor may determine whether the plurality of first points 410 and the plurality of second points 460 match each other, through the obtained vector. The processor may correct the separation between the plurality of first points 410 and the plurality of second points 460 based on the fact that the plurality of first points 410 and the plurality of second points 460 do not match each other.

As described above, the processor of the vehicle control apparatus according to an example may determine whether the plurality of first points 410 and the plurality of second points 460 match each other, based on polygons formed by the plurality of first points 410 and the plurality of second points 460. The processor may match data sets obtained by a plurality of LiDARs (e.g., a first LiDAR and a second LiDAR) by correcting the separation between the plurality of first points 410 and the plurality of second points 460. The processor may assist the driving of a host vehicle by matching data sets obtained by the plurality of LiDARs.

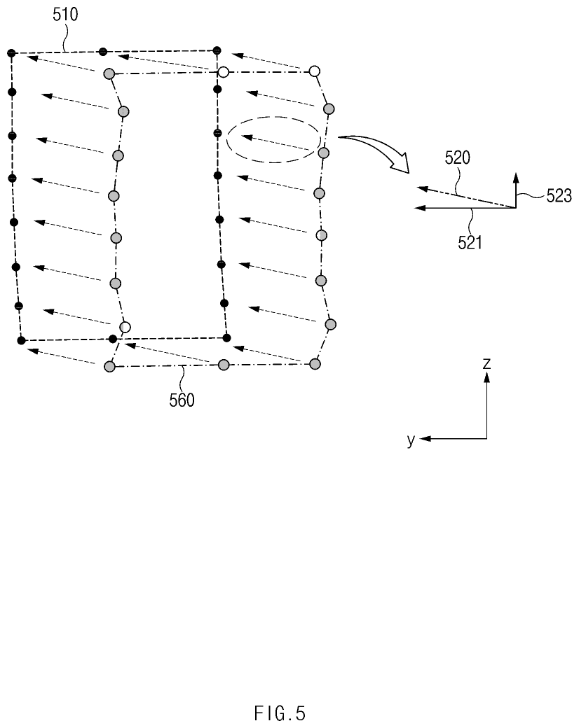

FIG. 5 shows an example of obtaining a vector by determining whether representative points match each other, in an example of the present disclosure.

Operations of FIG. 5 may be performed by the vehicle control apparatus 100 of FIG. 1, or may be performed by the processor 110 included in the vehicle control apparatus 100 of FIG. 1.

Referring to FIG. 5, a processor of the vehicle control apparatus according to an example may identify at least one of a plurality of first points 510 obtained by a first LiDAR, a plurality of second points 560 obtained by a second LiDAR, or any combination thereof. For example, the processor may separate the plurality of first points 510 and the plurality of second points 560 and may store the plurality of first points 410 and the plurality of second points 420 in a memory.

In an example, the processor may input representative points, which are included in the plurality of first points 510 and the plurality of second points 560, into an ICP algorithm. For example, the processor may obtain a vector 520 based on representative points of the plurality of first points 510 and representative points of the plurality of second points 560.

For example, the processor may use first representative points included in the plurality of first points 510 as a first input to be entered to the ICP algorithm. For example, the processor may use second representative points included in the plurality of second points 560 as a second input to be entered to the ICP algorithm.

In an example, the processor may obtain the vector 520 based on entering the first representative points included in the plurality of first points 510 into the ICP algorithm as the first input, and entering the second representative points included in the plurality of second points 560 into the ICP algorithm as the second input. For example, the vector 520 may represent a direction on a plane formed by a y-axis and a z-axis, among an x-axis, the y-axis, and the z-axis. For example, the vector 520 may include at least one of a y-axis component corresponding to a y-axis direction, a z-axis component corresponding to the z-axis direction, or any combination thereof.

In an example, the processor may identify whether the plurality of first points 510 matches the plurality of second points 560, through the vector 520. The processor may correct the separation between the plurality of first points 510 and the plurality of second points 560 by determining whether the plurality of first points 510 matches the plurality of second points 560.

For example, the processor may identify that the plurality of first points 510 does not match the plurality of second points 560, based on obtaining the vector 520 by using the ICP algorithm.

For example, the processor may identify at least one of a component 521 of the y-axis of the vector 520, a component 523 of the z-axis of the vector 520, or any combination thereof. For example, the processor may identify that at least one of the first LiDAR, the second LiDAR, or any combination thereof is distorted in a yaw direction, based on the component 521 of the y-axis of the vector 520. For example, the processor may identify that at least one of the first LiDAR, the second LiDAR, or any combination thereof is distorted in a pitch direction, based on the component 523 of the z-axis of the vector 523.

In an example, the processor may correct the separation between the plurality of first points 510 and the plurality of second points 560 by identifying that the plurality of first points 510 does not match the plurality of second points 560, based on the vector 520. In another example, the processor may reduce the reliability of a plurality of points obtained by the first LiDAR and the second LiDAR based on identifying that the plurality of first points 510 does not match the plurality of second points 560.

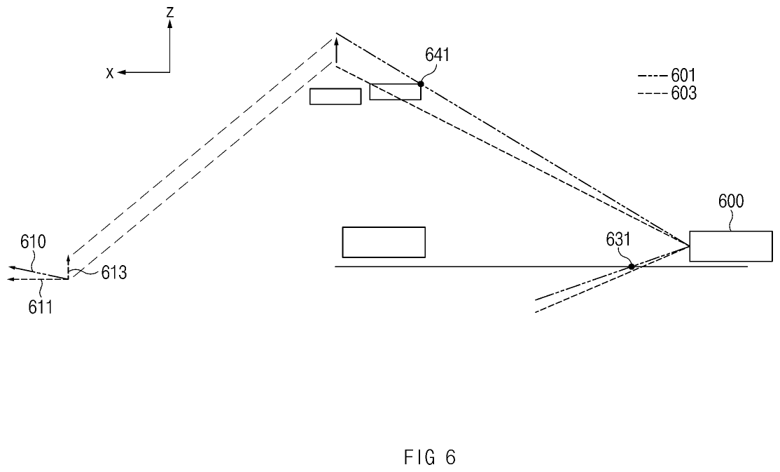

FIG. 6 shows an example of determining whether pitch directions between a plurality of points match each other, in an example of the present disclosure.

Operations of FIG. 6 may be performed by the vehicle control apparatus 100 of FIG. 1, or may be performed by the processor 110 included in the vehicle control apparatus 100 of FIG. 1.

Hereinafter, in FIG. 6, for convenience of description of field of view (FOV), the FOV is described based on a plane formed by an x-axis and a z-axis among the x-axis, a y-axis, and the z-axis. However, a vector 610 may be the vector 610 obtained by using the operations of FIGS. 1 to 5 and may include the vector 610 based on the y-axis and the z-axis.

Referring to FIG. 6, a processor of the vehicle control apparatus according to an example may compare a first FOV 601 based on surrounding objects of the host vehicle 200 with a second FOV 603 stored in a memory.

For example, the first FOV 601 may include a FOV based on at least one of a first LiDAR, a second LiDAR, or any combination thereof. For example, the second FOV 603 may include FOV at a point in time if at least one of the first LiDAR, the second LiDAR, or any combination thereof is mounted on a host vehicle 600. For example, the processor may store, in the memory, the FOV at a point in time if at least one of the first LiDAR, the second LiDAR, or any combination thereof is mounted on the host vehicle 600.

For example, to obtain the first FOV 601, the processor may identify a max angle point 641 corresponding to an external object located above the host vehicle 600. For example, to obtain the first FOV 601, the processor may identify a min angle point 631 among ground points.

The processor may obtain the first FOV 601 based on the max angle point 641 and the min angle point 631.

For example, the processor may determine whether the first FOV 601 matches the second FOV 603. The processor may identify that at least one of the first LiDAR, the second LiDAR, or any combination thereof included in the host vehicle 200 is distorted, based on identifying that the first FOV 601 does not match the second FOV 603.

For example, the first FOV 601 and the second FOV 603 may include at least one vertical-FOV (V-FOV) of the first LiDAR, the second LiDAR, or any combination thereof.

In an example, the processor may obtain the vector 610 based on a plurality of first points and a plurality of second points described in FIGS. 1 to 5. The processor may identify a component 611 of the y-axis and a component 613 of the z-axis from the vector 610 based on the y-axis and the z-axis. The processor may identify at least one of the component 611 of the y-axis, the component 613 of the z-axis, or any combination thereof.

In an example, the processor may identify that at least one of the first LiDAR, the second LiDAR, or any combination thereof is distorted in a pitch direction, by using the component 613 of the z-axis of the vector 610 among the component 611 of the y-axis of the vector 610 and the component 613 of the z-axis of the vector 610.

For example, the processor may identify that a mounting angle of at least one of the first LiDAR, the second LiDAR, or any combination thereof has changed, by using a difference between the first FOV 601 and the second FOV 603, and the component 613 of the z-axis of the vector 610. The processor may adjust at least one of a plurality of first points obtained by the first LiDAR, a plurality of second points obtained by the second LiDAR, or any combination thereof based on the fact that the mounting angle of at least one of the first LiDAR, the second LiDAR, or any combination thereof has changed. Alternatively or additionally, the processor may reduce the reliability of at least one of a plurality of first points obtained by the first LiDAR, a plurality of second points obtained by the second LiDAR, or any combination thereof based on the fact that the mounting angle of at least one of the first LiDAR, the second LiDAR, or any combination thereof has changed.

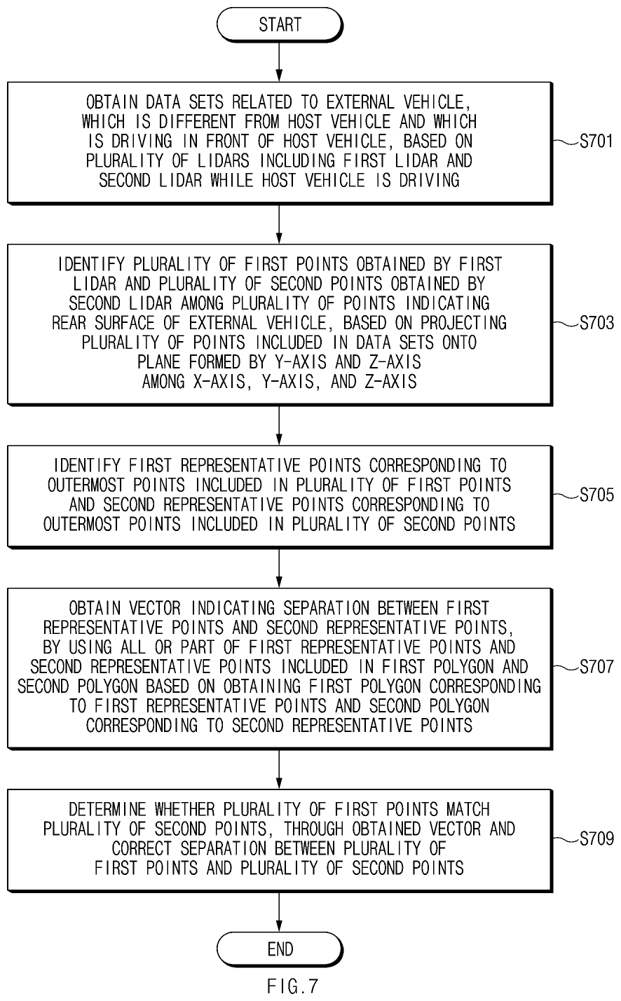

FIG. 7 shows an example of a flowchart of a vehicle control method, according to an example of the present disclosure.

Hereinafter, it is assumed that the vehicle controlling apparatus 100 of FIG. 1 performs the process of FIG. 7. In addition or alternative, in a description of FIG. 7, it may be understood that an operation described as being performed by an apparatus is controlled by the processor 110 of the vehicle control apparatus 100.

At least one of operations of FIG. 7 may be performed by the vehicle control apparatus 100 of FIG. 1. Each of the operations in FIG. 7 may be performed sequentially, but is not necessarily sequentially performed. For example, the order of operations may be changed, and at least two operations may be performed in parallel.

Referring to FIG. 7, in operation S701, a vehicle control method according to an example may include an operation of obtaining data sets related to an external vehicle, which is different from a host vehicle and which is driving in front of the host vehicle, based on a plurality of LiDARs including a first LiDAR and a second LiDAR while a host vehicle is driving.

In operation S703, the vehicle control method according to an example may include an operation of projecting a plurality of points included in data sets onto a plane formed by a y-axis and a z-axis among an x-axis, the y-axis, and the z-axis. The vehicle control method may include an operation of identifying a plurality of first points obtained by the first LiDAR and a plurality of second points obtained by the second LiDAR among a plurality of points indicating the rear surface of the external vehicle, based on projecting the plurality of points included in the data sets onto a plane formed by the y-axis and the z-axis.

For example, the vehicle control method may include an operation of identifying the plurality of first points obtained by the first LiDAR and the plurality of second points obtained by the second LiDAR based on sampling the plurality of points.

In operation S705, the vehicle control method according to an example may include an operation of identifying first representative points corresponding to outermost points included in the plurality of first points and second representative points corresponding to outermost points included in the plurality of second points.

For example, the vehicle control method may include an operation of identifying first minimum values based on the y-axis and first maximum values based on the y-axis on layers on each of which the plurality of first points are identified. For example, the vehicle control method may include an operation of obtaining first intermediate values of the plurality of first points, on the top layer and the bottom layer, on each of which the plurality of first points are identified.

For example, at least one of the first minimum values, the first maximum values, the first intermediate values, or any combination thereof may be referred to as first representative values.

For example, the vehicle control method may include an operation of identifying second minimum values based on the y-axis and second maximum values based on the y-axis on layers on each of which a plurality of second points are identified. For example, the vehicle control method may include an operation of obtaining second intermediate values of the plurality of second points, on the top layer and the bottom layer on each of which the plurality of second points are identified.

For example, at least one of the second minimum values, the second maximum values, the second intermediate values, or any combination thereof may be referred to as second representative values.

In operation S707, the vehicle control method according to an example may include an operation of obtaining a first polygon corresponding to the first representative points and a second polygon corresponding to the second representative points. For example, the vehicle control method may include an operation of obtaining the first polygon by connecting the first representative points. For example, the vehicle control method may include an operation of obtaining the second polygon by connecting the second representative points.

The vehicle control method according to an example may include an operation of obtaining a vector indicating the separation between the first representative points and the second representative points, by using all or part of the first representative points included in the first polygon and the second representative points included in the second polygon.

In operation S709, the vehicle control method according to an example may include an operation of determining whether the plurality of first points match the plurality of second points, through the obtained vector. The vehicle control method may determine whether the plurality of first points match the plurality of second points, based on at least one of the y-axis component of the obtained vector, the z-axis component of the obtained vector, or any combination thereof.

The vehicle control method may include an operation of determining whether a plurality of first points match a plurality of second points, through the obtained vector and correcting the separation between the plurality of first points and the plurality of second points.

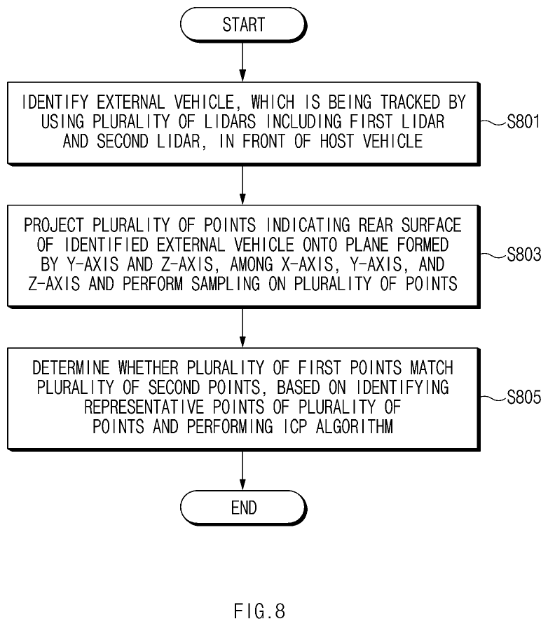

FIG. 8 shows an example of a flowchart of a vehicle control method, according to an example of the present disclosure.

Hereinafter, it is assumed that the vehicle controlling apparatus 100 of FIG. 1 performs the process of FIG. 8. In addition or alternative, in a description of FIG. 8, it may be understood that an operation described as being performed by an apparatus is controlled by the processor 110 of the vehicle control apparatus 100.

At least one of operations of FIG. 8 may be performed by the vehicle control apparatus 100 of FIG. 1. Each of the operations in FIG. 8 may be performed sequentially, but is not necessarily sequentially performed. For example, the order of operations may be changed, and at least two operations may be performed in parallel.

Referring to FIG. 8, in operation S801, a vehicle control method according to an example may include an operation of identifying an external vehicle, which is being tracked by using a plurality of LiDARs including a first LiDAR and a second LiDAR, in front of a host vehicle.

For example, the vehicle control method may include an operation of selecting an external vehicle based on specified conditions and identifying a plurality of points corresponding to a rear surface of the selected external vehicle. For example, the vehicle control method may include an operation of identifying a plurality of points corresponding to the rear surface of an external vehicle based on identifying an external vehicle that satisfies at least one of a first condition, a second condition, a third condition, or any combination thereof.

For example, the first condition may be related to a case where the external vehicle is driving straight in front of the host vehicle. For example, the second condition may be related to a case where the external vehicle is driving in front of the host vehicle at a distance greater than or equal to a first specified distance and less than or equal to a second specified distance. For example, the third condition may relate to a range identified by the first LiDAR and the second LiDAR included in the host vehicle.

For example, a case where the first condition is satisfied may include a case where the external vehicle is driving straight in front of the host vehicle. For example, a case where the second condition is satisfied may include a case where the external vehicle is driving in front of the host vehicle at a distance greater than or equal to the first specified distance and less than or equal to the second specified distance. For example, a case where the third condition is satisfied may include a case where the external vehicle is identified in an area where a first specified area identified by the first LiDAR included in the host vehicle superimposes a second specified area identified by the second LiDAR included in the host vehicle.

In operation S803, the vehicle control method according to an example may include an operation of projecting a plurality of points indicating the rear surface of the identified external vehicle onto a plane formed by the y-axis and the z-axis, among the x-axis, the y-axis, and the z-axis. The vehicle control method according to an example may include an operation of performing sampling on the plurality of points based on projecting the plurality of points onto a plane formed by the y-axis and the z-axis.

The vehicle control method according to an example may include an operation of identifying a plurality of first points obtained by the first LiDAR and a plurality of second points obtained by the second LiDAR based on sampling the plurality of points.

For example, the vehicle control method may include an operation of identifying the plurality of first points obtained by the first LiDAR, and identifying the plurality of second points obtained by the second LiDAR based on sampling the plurality of points.

For example, the vehicle control method may include an operation of separating and identifying the plurality of first points obtained by the first LiDAR and the plurality of second points obtained by the second LiDAR based on sampling the plurality of points.

In operation S805, the vehicle control method according to an example may include an operation of identifying a representative point of the plurality of points thus sampled. For example, the vehicle control method may include an operation of obtaining the plurality of first points obtained by the first LiDAR, and obtaining the plurality of second points obtained by the second LiDAR, based on sampling the plurality of points.

The vehicle control method may include an operation of identifying first representative points of the plurality of first points, and second representative points of the plurality of second points. The vehicle control method may include an operation of identifying the first representative points and the second representative points and performing an ICP algorithm.

The vehicle control method according to an example may include an operation of determining whether the plurality of first points match the plurality of second points, based on identifying representative points of a plurality of points and performing the ICP algorithm.

According to an example, the vehicle control method may include an operation of obtaining a vector indicating the separation between the first representative points and the second representative points, by respectively using the first representative points of the plurality of first points and the second representative points of the plurality of second points as a first input and a second input of the ICP algorithm.

For example, the vehicle control method may include an operation of identifying that the plurality of first points do not match the plurality of second points in a yaw direction, based on the y-axis component of the obtained vector. For example, the vehicle control method may include an operation of identifying that the plurality of first points do not match the plurality of second points in a pitch direction, based on the z-axis component of the obtained vector.

In an example, the vehicle control method may include a correction operation such that the plurality of first points are capable of matching the plurality of second points based on the fact that the plurality of first points do not match the plurality of second points in at least one direction of the yaw direction, the pitch direction, or any combination thereof.

In another example, the vehicle control method may reduce the reliability of the plurality of first points and the plurality of second points based on the fact that the plurality of first points do not match the plurality of second points in at least one direction of the yaw direction, the pitch direction, or any combination thereof.

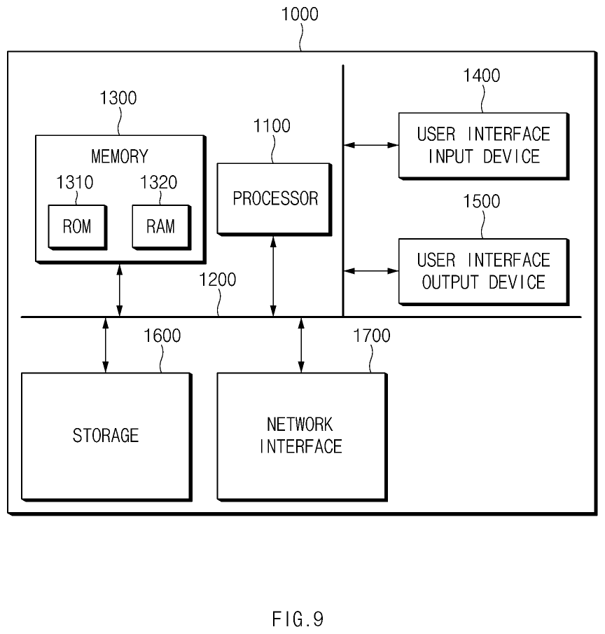

FIG. 9 shows an example of a computing system including a vehicle control apparatus, according to an example of the present disclosure.

Referring to FIG. 9, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively or additionally, the storage medium may be integrated with the processor 1100. The processor and storage medium may be implemented with an application specific integrated circuit (ASIC). The ASIC may be provided in a user terminal. Alternatively or additionally, the processor and storage medium may be implemented with separate components in the user terminal.

The present disclosure has been made to solve the above-mentioned problems occurring in the prior art while advantages achieved by the prior art are maintained intact.

An example of the present disclosure provides a vehicle control apparatus that may determine whether a plurality of points obtained by a plurality of LiDARs are matched with each other, and may match the plurality of points if the plurality of points are not matched with each other, and a method thereof.

An example of the present disclosure provides a vehicle control apparatus that may obtain a vector based on inputting the plurality of points into a specified algorithm, may identify distortion of LiDARs by using the obtained vector, and may correct the distortion of LiDAR, and a method thereof.

An example of the present disclosure provides a vehicle control apparatus that may correct either a plurality of first points or a plurality of second points if the plurality of first points do not match the plurality of second points, and may prevent the interruption of a vehicle control system including the vehicle control apparatus, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a first light detection and ranging (LiDAR), a second LiDAR, and a processor. The processor may obtain data sets related to an external vehicle, which is different from a host vehicle and which is driving in front of the host vehicle, based on a plurality of LiDARs including the first LiDAR and the second LiDAR, while the host vehicle is driving; may identify a plurality of first points obtained by the first LiDAR and a plurality of second points obtained by the second LiDAR among a plurality of points indicating a rear surface of the external vehicle, based on projecting the plurality of points included in the data sets, onto a plane formed by a second axis and a third axis among a first axis, the second axis, and the third axis; may identify first representative points corresponding to outermost points included in the plurality of first points and second representative points corresponding to outermost points included in the plurality of second points; obtain a vector indicating a separation between the first representative points and the second representative points based on obtaining a first polygon corresponding to the first representative points and a second polygon corresponding to the second representative points, by using all or part of the first representative points and the second representative points included in the first polygon and the second polygon; and may identify whether the plurality of first points match the plurality of second points, through the obtained vector, and correct a separation between the plurality of first points and the plurality of second points.

In an example, the processor may obtain the first polygon and the second polygon based on the external vehicle being identified at a distance from the host vehicle that is greater than or equal to a first specified distance and is smaller than or equal to a second specified distance exceeding the first specified distance.

In an example, the first LiDAR may identify an external object in a first specified range. The second LiDAR may identify an external object in a second specified range. The processor may obtain the first polygon and the second polygon based on the external vehicle being identified in a range where the first specified range and the second specified range are superimposed with each other.

In an example, the processor may obtain the first polygon and the second polygon while the external vehicle is driving straight in front of the host vehicle.

In an example, the processor may separate and identify the plurality of first points and the plurality of second points based on sampling the plurality of points.

In an example, the processor may identify first minimum values and first maximum values of the plurality of first points based on the second axis, on layers on each of which the plurality of first points are identified, may identify first intermediate values of the plurality of first points on a top layer and a bottom layer, each of which the plurality of first points is identified, may obtain the first polygon by connecting the first minimum values, the first maximum values, and the first intermediate values, may identify second minimum values and second maximum values of the plurality of second points based on the second axis, on layers on each of which the plurality of second points are identified, may identify second intermediate values of the plurality of second points on a top layer and a bottom layer, each of which the plurality of second points is identified, and may obtain the second polygon by connecting the second minimum values, the second maximum values, and the second intermediate values.

In an example, on a basis of inputting the first representative points based on the plurality of first points, and the second representative points based on the plurality of second points into an ICP algorithm, the processor may obtain the vector based on one of the first minimum values included in one of the layers, and one of the second minimum values included in a layer of the same order as the one of the first minimum values, may obtain the vector based on one of the first maximum values included in one of the layers, and one of the second maximum values included in a layer of the same order as the one of the first maximum values, may obtain the vector based on one of the first intermediate values included in the top layer, on which the plurality of first points are identified, and one of the second intermediate values included in the top layer on which the plurality of second points are identified, or may obtain the vector based on one of the first intermediate values included in the bottom layer on which the plurality of first points are identified, and one of the second intermediate values included in the bottom layer on which the plurality of second points are identified.

In an example, the processor may identify that the plurality of first points do not match the plurality of second points in a yaw direction, based on identifying a component of the second axis in the obtained vector and may correct the separation between the plurality of first points and the plurality of second points based on the component of the second axis in the obtained vector.

In an example, the processor may identify that the plurality of first points do not match the plurality of second points in a pitch direction, based on identifying a component of the third axis in the obtained vector and may correct the separation between the plurality of first points and the plurality of second points based on the component of the third axis in the obtained vector.

In an example, the plane formed by the second axis and the third axis may include a first plane. The processor may obtain a top point and a bottom point, which are obtained by the plurality of LiDARs, on a second plane, which is formed by the first axis and the third axis and is different from the first plane, may identify that the plurality of first points do not match the plurality of second points in a pitch direction, based on identifying at least one of the top point, the bottom point, a component of the third axis of the obtained vector, or a combination of the top point, the bottom point, and the component of the third axis, and may correct the separation between the plurality of first points and the plurality of second points based on at least one of the top point, the bottom point, the component of the third axis of the obtained vector, or a combination of the top point, the bottom point, and the component of the third axis.

According to an example of the present disclosure, a vehicle control method may include obtaining data sets related to an external vehicle, which is different from a host vehicle and which is driving in front of the host vehicle, based on a plurality of LiDARs including a first LiDAR and a second LiDAR, while the host vehicle is driving, identifying a plurality of first points obtained by the first LiDAR and a plurality of second points obtained by the second LiDAR among a plurality of points indicating a rear surface of the external vehicle, based on projecting the plurality of points included in the data sets, onto a plane formed by a second axis and a third axis among a first axis, the second axis, and the third axis, identifying first representative points corresponding to outermost points included in the plurality of first points and second representative points corresponding to outermost points included in the plurality of second points, obtaining a vector indicating a separation between the first representative points and the second representative points based on obtaining a first polygon corresponding to the first representative points and a second polygon corresponding to the second representative points, by using all or part of the first representative points and the second representative points included in the first polygon and the second polygon, and identifying whether the plurality of first points match the plurality of second points, through the obtained vector, and correcting a separation between the plurality of first points and the plurality of second points.

According to an example, the vehicle control method may further include obtaining the first polygon and the second polygon based on the external vehicle being identified at a distance from the host vehicle that is greater than or equal to a first specified distance and is smaller than or equal to a second specified distance exceeding the first specified distance.

In an example, the first LiDAR may identify an external object in a first specified range. The second LiDAR may identify an external object in a second specified range. The vehicle control method may further include obtaining the first polygon and the second polygon based on the external vehicle being identified in a range where the first specified range and the second specified range are superimposed with each other.

According to an example, the vehicle control method may further include obtaining the first polygon and the second polygon while the external vehicle is driving straight in front of the host vehicle.

According to an example, the vehicle control method may further include separating and identifying the plurality of first points and the plurality of second points based on sampling the plurality of points.

According to an example, the vehicle control method may further include identifying first minimum values and first maximum values of the plurality of first points based on the second axis, on layers on each of which the plurality of first points are identified, identifying first intermediate values of the plurality of first points on a top layer and a bottom layer, each of which the plurality of first points identified, obtaining the first polygon by connecting the first minimum values, the first maximum values, and the first intermediate values, identifying second minimum values and second maximum values of the plurality of second points based on the second axis, on layers on each of which the plurality of second points are identified, identifying second intermediate values of the plurality of second points on a top layer and a bottom layer, each of which the plurality of second points is identified, and obtaining the second polygon by connecting the second minimum values, the second maximum values, and the second intermediate values.

According to an example, the vehicle control method may further include, on a basis of inputting the first representative points based on the plurality of first points, and the second representative points based on the plurality of second points into an ICP algorithm, obtaining the vector based on one of the first minimum values included in one of the layers, and one of the second minimum values included in a layer of the same order as the one of the first minimum values, obtaining the vector based on one of the first maximum values included in one of the layers, and one of the second maximum values included in a layer of the same order as the one of the first maximum values, obtaining the vector based on one of the first intermediate values included in the top layer, on which the plurality of first points are identified, and one of the second intermediate values included in the top layer on which the plurality of second points are identified, or obtaining the vector based on one of the first intermediate values included in the bottom layer on which the plurality of first points are identified, and one of the second intermediate values included in the bottom layer on which the plurality of second points are identified.

According to an example, the vehicle control method may further include identifying that the plurality of first points do not match the plurality of second points in a yaw direction, based on identifying a component of the second axis in the obtained vector, and correcting the separation between the plurality of first points and the plurality of second points based on the component of the second axis in the obtained vector.

According to an example, the vehicle control method may further include identifying that the plurality of first points do not match the plurality of second points in a pitch direction, based on identifying a component of the third axis in the obtained vector, and correcting the separation between the plurality of first points and the plurality of second points based on the component of the third axis in the obtained vector.

In an example, the plane formed by the second axis and the third axis may include a first plane. The vehicle control method may further include obtaining a top point and a bottom point, which are obtained by the plurality of LiDARs, on a second plane, which is formed by the first axis and the third axis and is different from the first plane, identifying that the plurality of first points do not match the plurality of second points in a pitch direction, based on identifying at least one of the top point, the bottom point, a component of the third axis of the obtained vector, or a combination of the top point, the bottom point, and the component of the third axis, and correcting the separation between the plurality of first points and the plurality of second points based on at least one of the top point, the bottom point, the component of the third axis of the obtained vector, or a combination of the top point, the bottom point, and the component of the third axis.

The above description is merely an example of the technical idea of the present disclosure, various modifications and modifications may be made by one skilled in the art without departing from the essential characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

According to an example of the present disclosure, an apparatus may determine whether a plurality of points obtained by a plurality of LiDARs are matched with each other, and may match the plurality of points if the plurality of points are not matched.

Moreover, according to an example of the present disclosure, the apparatus may obtain a vector based on inputting the plurality of points into a specified algorithm, may identify distortion of LiDARs by using the obtained vector, and may correct the distortion of LiDAR.

Furthermore, according to an example of the present disclosure, the apparatus may correct either a plurality of first points or a plurality of second points if the plurality of first points and the plurality of second points do not match each other, and may prevent the interruption of a vehicle control system including the vehicle control apparatus.

Besides, a variety of effects directly or indirectly understood through this disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a vehicle, the apparatus comprising:
a first sensor;
a second sensor; and
a processor,
wherein the processor is configured to:
obtain, from the first sensor and the second sensor, data sets related to a moving object in front of the vehicle that is driving along a first axis;
project a plurality of points included in the data sets onto a plane formed by a second axis and a third axis, wherein:
the plurality of points indicate a rear surface of the moving object;
the second axis, being perpendicular to the first axis, lies in a horizontal plane; and
the third axis, being perpendicular to the first axis and the second axis, lies in a vertical plane;
determine, based on the projection,
a plurality of first points, of the plurality of points, obtained by the first sensor, and
a plurality of second points, of the plurality of points, obtained by the second sensor;
determine a first subset of points included in the plurality of first points and a second subset of points included in the plurality of second points;
obtain, based on the first subset, a first polygon;
obtain, based on the second subset, a second polygon;
obtain, based on points of the first polygon and the second polygon, a vector indicating a separation between the first subset and the second subset;
determine, based on the vector, whether the plurality of first points match the plurality of second points;
adjust, based on the determination of whether the plurality of first points match the plurality of second points, a separation between the plurality of first points and the plurality of second points; and
output a signal indicating the adjusted separation.

2. The apparatus of claim 1, wherein the processor is configured to:
obtain the first polygon and the second polygon based on the moving object being identified at a distance from the vehicle, wherein the distance is greater than or equal to a first threshold distance and is smaller than or equal to a second threshold distance exceeding the first threshold distance.

3. The apparatus of claim 1, wherein the first sensor is configured to detect an external object in a first range,
wherein the second sensor is configured to detect the external object in a second range different from the first range, and
wherein the processor is configured to:
obtain the first polygon and the second polygon based on the moving object being identified in a range where the first range and the second range overlap with each other.

4. The apparatus of claim 1, wherein the processor is configured to:
obtain the first polygon and the second polygon based on the moving object moving straight in front of the vehicle.

5. The apparatus of claim 1, wherein the processor is configured to:
identify, based on sampling the plurality of points, the plurality of first points and the plurality of second points.

6. The apparatus of claim 1, wherein the processor is configured to:
determine first minimum values and first maximum values of first points on first layers, wherein each layer of the first layers is formed of a subset of points, of the plurality of first points, along the second axis;
determine first intermediate values of first intermediate points on a top most layer of the first layers and a bottom most layer of the first layers;
obtain the first polygon by connecting the first minimum values, the first maximum values, and the first intermediate values;
determine second minimum values and second maximum values of second points on second layers, wherein each layer of the second layers is formed of a subset of points, of the plurality of second points, along the second axis;
determine second intermediate values of second intermediate points on a top most layer of the second layers and a bottom most layer of the second layers; and
obtain the second polygon by connecting the second minimum values, the second maximum values, and the second intermediate values.

7. The apparatus of claim 6, wherein the processor is configured to:
obtain the vector based on:
one of the first minimum values of the first points on a first one of the first layers, and
one of the second minimum values of the second points on a first one of the second layers, wherein the first one of the second layers is of a same order as the first one of the first layers;
obtain the vector based on:
one of the first maximum values of the first points on a second one of the first layers, and
one of the second maximum values of the second points on a second one of the second layers, wherein the second one of the second layers is of a same order as the second one of the first layers;
obtain the vector based on:
one of the first intermediate values of the first intermediate points on the top most layer of the first layers, and
one of the second intermediate values of the second intermediate points on the top most layer of the second layers; or
obtain the vector based on:
one of the first intermediate values of the first intermediate points on the bottom most layer of the first layers, and
one of the second intermediate values of the second intermediate points on the bottom most layer of the second layers.

8. The apparatus of claim 1, wherein the processor is configured to:
determine that the plurality of first points do not match the plurality of second points in a yaw direction, based on identifying a component of the second axis in the obtained vector; and
adjust the separation between the plurality of first points and the plurality of second points based on the component of the second axis in the obtained vector.

9. The apparatus of claim 1, wherein the processor is configured to:
determine that the plurality of first points do not match the plurality of second points in a pitch direction, based on identifying a component of the third axis in the obtained vector; and
adjust the separation between the plurality of first points and the plurality of second points based on the component of the third axis in the obtained vector.

10. The apparatus of claim 1, wherein the plane includes a first plane, and
wherein the processor is configured to:
obtain, based on sensing data of the first sensor and the second sensor, a top point and a bottom point on a second plane, which is formed by the first axis and the third axis and is different from the first plane;
determine that the plurality of first points do not match the plurality of second points in a pitch direction, based on identifying at least one of:
the top point,
the bottom point, or
a component of the third axis of the obtained vector; and
adjust the separation between the plurality of first points and the plurality of second points based on at least one of:
the top point,
the bottom point, or
the component of the third axis of the obtained vector.

11. A method for controlling a vehicle, the method comprising:
obtaining, from a first sensor and a second sensor, data sets related to a moving object in front of the vehicle that is driving along a first axis;
projecting a plurality of points included in the data sets onto a plane formed by a second axis and a third axis, wherein:
the plurality of points indicate a rear surface of the moving object;
the second axis, being perpendicular to the first axis, lies in a horizontal plane; and
the third axis, being perpendicular to the first axis and the second axis, lies in a vertical plane;
determining, based on the projecting,
a plurality of first points, of the plurality of points, obtained by the first sensor, and
a plurality of second points, of the plurality of points, obtained by the second sensor;
determining a first subset of points included in the plurality of first points and a second subset of points included in the plurality of second points;
obtaining, based on the first subset, a first polygon;
obtaining, based on the second subset, a second polygon;
obtaining, based on points of the first polygon and the second polygon, a vector indicating a separation between the first subset and the second subset;
determining, based on the vector, whether the plurality of first points match the plurality of second points;
adjusting, based on the determining whether the plurality of first points match the plurality of second points, a separation between the plurality of first points and the plurality of second points; and
outputting a signal indicating the adjusted separation.

12. The method of claim 11, further comprising:
obtaining the first polygon and the second polygon based on the moving object being identified at a distance from the vehicle, wherein the distance is greater than or equal to a first threshold distance and is smaller than or equal to a second threshold distance exceeding the first threshold distance.

13. The method of claim 11, further comprising:
detecting, using the first sensor, an external object in a first range,
detecting, using the second sensor, the external object in a second range different from the first range, and
obtaining the first polygon and the second polygon based on the moving object being identified in a range where the first range and the second range overlap with each other.

14. The method of claim 11, further comprising:
obtaining the first polygon and the second polygon based on the moving object moving straight in front of the vehicle.

15. The method of claim 11, further comprising:
identifying, based on sampling the plurality of points, the plurality of first points and the plurality of second points.

16. The method of claim 11, further comprising:
determining first minimum values and first maximum values of first points on first layers, wherein each layer of the first layers is formed of a subset of points, of the plurality of first points, along the second axis;
determining first intermediate values of first intermediate points on a top most layer of the first layers and a bottom most layer of the first layers;
obtaining the first polygon by connecting the first minimum values, the first maximum values, and the first intermediate values;
determining second minimum values and second maximum values of second points on second layers, wherein each layer of the second layers is formed of a subset of points, of the plurality of second points, along the second axis;
determining second intermediate values of second intermediate points on a top most layer of the second layers and a bottom most layer of the second layers; and
obtaining the second polygon by connecting the second minimum values, the second maximum values, and the second intermediate values.

17. The method of claim 16, further comprising:
obtaining the vector based on:
one of the first minimum values of the first points on a first one of the first layers, and
one of the second minimum values of the second points on a first one of the second layers, wherein the first one of the second layers is of a same order as the first one of the first layers;
obtaining the vector based on:
one of the first maximum values of the first points on a second one of the first layers, and
one of the second maximum values of the second points on a second one of the second layers, wherein the second one of the second layers is of a same order as the second one of the first layers;
obtaining the vector based on:
one of the first intermediate values of the first intermediate points on the top most layer of the first layers, and
one of the second intermediate values of the second intermediate points on the top most layer of the second layers; or
obtaining the vector based on:
one of the first intermediate values of the first intermediate points on the bottom most layer of the first layers, and
one of the second intermediate values of the second intermediate points on the bottom most layer of the second layers.

18. The method of claim 11, further comprising:
determining that the plurality of first points do not match the plurality of second points in a yaw direction, based on identifying a component of the second axis in the obtained vector; and
adjusting the separation between the plurality of first points and the plurality of second points based on the component of the second axis in the obtained vector.

19. The method of claim 11, further comprising:
determining that the plurality of first points do not match the plurality of second points in a pitch direction, based on identifying a component of the third axis in the obtained vector; and
adjusting the separation between the plurality of first points and the plurality of second points based on the component of the third axis in the obtained vector.

20. The method of claim 11, wherein the plane includes a first plane, and wherein the method further comprises:
obtaining, based on sensing data of the first sensor and the second sensor, a top point and a bottom point on a second plane, which is formed by the first axis and the third axis and is different from the first plane;
determining that the plurality of first points do not match the plurality of second points in a pitch direction, based on identifying at least one of:
the top point,
the bottom point, or
a component of the third axis of the obtained vector; and
adjusting the separation between the plurality of first points and the plurality of second points based on at least one of:
the top point,
the bottom point, or
the component of the third axis of the obtained vector.
